(19) United States
(12) Patent Application Publication
(10) Pub. No.: US 2026/0012837 A1
(43) Pub. Date: Jan. 8, 2026

(54) Artificial Intelligence-Based Dynamic System Selection Policy Adjustment

(71) Applicant: MediaTek Inc., Hsinchu City (TW)

(72) Inventors: Chia-Shing Tai, Hsinchu City (TW); Shao-Lun Tseng, Hsinchu City (TW); Yun-Hao Wang, Hsinchu City (TW); Jian-Nong Li, Hsinchu City (TW); Chih-Hung Lee, Hsinchu City (TW)

(21) Appl. No.: 18/761,417

(22) Filed: Jul. 2, 2024

(51) Int. Cl. H04W 28/02; H04L 41/16; H04W 28/08

(52) U.S. Cl. CPC H04W 28/0226; H04L 41/16; H04W 28/0925

(57) ABSTRACT

Techniques pertaining to training artificial intelligence (AI)-based dynamic system selection policy adjustment in wireless communications are described. An apparatus (e.g., user equipment (UE)) utilizes an AI model to determine a mobility scenario of an environment in which the UE is situated. The apparatus adjusts one or more parameters used in a system selection according to a result of the determining.

### TECHNICAL FIELD

The present disclosure is generally related to wireless communications and, more particularly, to artificial intelligence (AI)-based dynamic system selection policy adjustment in wireless communications.

### BACKGROUND

Unless otherwise indicated herein, approaches described in this section are not prior art to the claims listed below and are not admitted as prior art by inclusion in this section.

In a modem system design for wireless communications, some of existing designs are based on rule of thumbs and hard code-defined behavior, which may be difficult to formulate and hard to meet dynamically changing scenarios in real-world networks. For example, when services are lost, a user equipment (UE) can follow a fixed order to perform carrier scan. It may take the UE certain amount of time to gain services back if the UE is in the middle of a full band search when the signal (re) appears. Moreover, when the UE stays in a no-signal area to perform a hard code-defined full band carrier search, unnecessary and wasteful power consumption may occur. Therefore, there is a need for a solution of AI-based dynamic system selection policy adjustment in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to AI-based dynamic system selection policy adjustment in wireless communications. It is believed that implementations of the various proposed schemes may address or otherwise alleviate the aforementioned issue(s). For instance, under the proposed schemes, AI-based mobility detection may be utilized to detect the environment (in which a UE is situated) as a policy adjusting factor to replace the hard code-defined behavior, thereby enhancing flexibility and efficiency in system selection policy.

In one aspect, a method may involve a processor of a UE utilizing an AI model to determine a mobility scenario of an environment in which the UE is situated. The method may also involve the processor adjusting one or more parameters used in a system selection according to a result of the determining.

In another aspect, an apparatus implementable in a UE may include a transceiver configured to communicate wirelessly and a processor coupled to the transceiver. The processor may utilize an AI model to determine a mobility scenario of an environment in which the UE is situated. The processor may adjust one or more parameters used in a system selection according to a result of the determining.

It is noteworthy that, although description provided herein may be in the context of certain radio access technologies, networks, and network topologies for wireless communication, such as 5th Generation (5G)/New Radio (NR) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example process under a proposed scheme in accordance with the present disclosure.

FIG. 3 is a diagram of an example scenario under a proposed scheme in accordance with the present disclosure.

FIG. 4 is a block diagram of an example communication system under a proposed scheme in accordance with the present disclosure.

FIG. 5 is a flowchart of an example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to AI-based dynamic system selection policy adjustment in wireless communications. According to the present disclosure, a number of possible solutions may be implemented separately or jointly. That is, although these possible solutions may be described below separately, two or more of these possible solutions may be implemented in one combination or another.

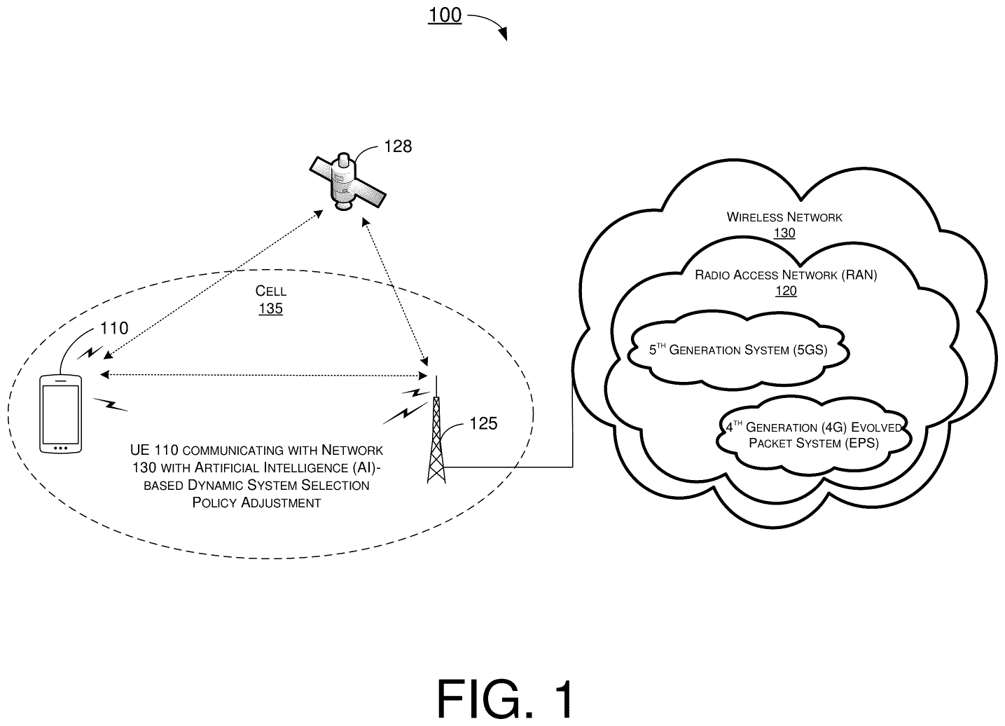

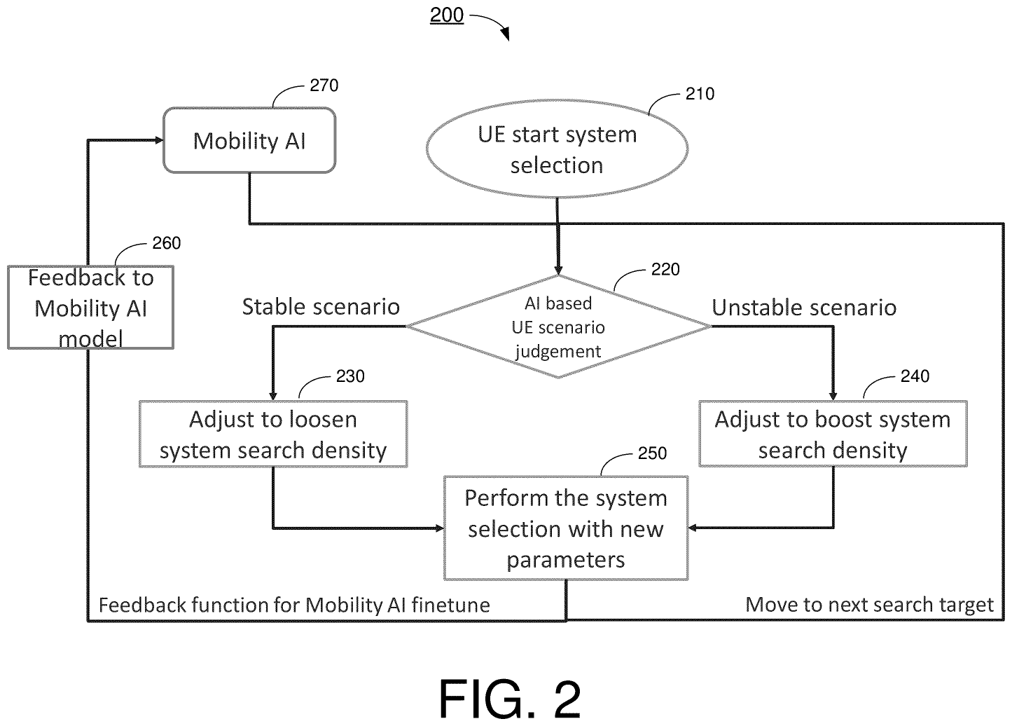

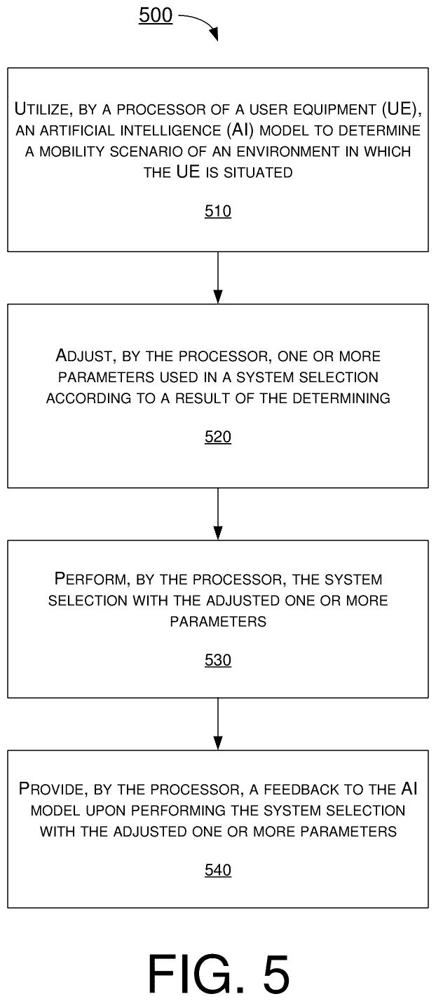

FIG. 1 illustrates an example network environment 100 in which various solutions and schemes in accordance with the present disclosure may be implemented. FIG. 2˜FIG. 5 illustrate examples of implementation of various proposed schemes in network environment 100 in accordance with the present disclosure. The following description of various proposed schemes is provided with reference to FIG. 1˜FIG. 5.

Referring to FIG. 1, network environment 100 may involve a UE 110 in wireless communication with a radio access network (RAN) 120 (e.g., a 5G NR mobile network or another type of network such as a non-terrestrial network (NTN)). UE 110 may be in wireless communication with RAN 120 via a terrestrial network node 125 (e.g., base station, eNB, gNB or transmit-and-receive point (TRP)) or a non-terrestrial network node 128 (e.g., satellite) and UE 110 may be within a coverage range of a cell 135 associated with terrestrial network node 125 and/or non-terrestrial network node 128. RAN 120 may be a part of a wireless network 130. In network environment 100, UE 110 and wireless network 130 (via terrestrial network node 125 and/or non-terrestrial network node 128) may implement various schemes pertaining to AI-based dynamic system selection policy adjustment in wireless communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Under a proposed scheme in accordance with the present disclosure, AI-based mobility detection and system selection policy adjustment may be performed. Under the proposed scheme, UE 110 may consider several control parameters related to system selection policy. UE 110 may gradually adjust UE system selection parameters according to a mobility scenario associated with UE 110 at the current time.

Under various proposed schemes in accordance with the present disclosure, AI-based mobility detection may be utilized to detect the environment (in which UE 110 is situated) as a policy adjusting factor to replace the hard code-defined behavior, thereby enhancing flexibility and efficiency in system selection policy. Under a proposed scheme, UE 110 may classify mobility scenarios into a plurality of groups of scenarios and mark the variability of each group. For instance, a stable scenario may be marked or otherwise identified as “low mobility”, and an unstable scenario may be marked or otherwise identified as “high mobility.” Under another proposed scheme, UE 110 may start a system selection (e.g., involving a public land mobile network (PLMN) search or a cell search) with a static search policy and gradually adjust the policy while UE 110 stays in a stable scenario, and vice versa. Under yet another proposed scheme, additional flexibility may be provided in that parameter setting, scenario grouping, and gear parameters may be configurable.

FIG. 2 illustrates an example process 200 under a proposed scheme in accordance with the present disclosure. Process 200 may pertain to a logic flow with respect to implementing the various proposed schemes described herein. Referring to FIG. 2, at 210, UE 110 may start a system selection procedure. At 220, an AI-based UE scenario determination may be performed to determine the scenario (e.g., mobility scenario) in which UE 110 is situated. For instance, in an event that it is determined (e.g., by a mobility AI model) that UE 110 is in a stable scenario (e.g., UE 110 is static or otherwise non-moving), process 200 may proceed from 220 to 230. Conversely, in an evet that it is determined (e.g., by the mobility AI model) that UE 110 is in an unstable scenario (e.g., UE 110 is non-static or otherwise moving due to walking or driving by a user of UE 110), process 200 may proceed from 220 to 240. The mobility AI model may utilize input from various sensors, devices and tools associated with UE 110 to determine the scenario such as, for example, global positioning system (GPS) chip, gyroscope, accelerometer, camera, radar, and the like. At 230, a system search density (e.g., in terms of how frequent searches are conducted) of the system selection procedure may be adjusted to be loosened or otherwise decreased (e.g., lower search frequency), corresponding to the stable scenario associated with UE 110. At 240, the system search density of the system selection procedure may be adjusted to be boosted or otherwise increased (e.g., higher search frequency), corresponding to the unstable scenario associated with UE 110. Process 200 may proceed from 230 or 240 to 250. At 250, system selection may be performed with one or more new or adjusted system selection control parameters, such as the loosened or boosted system search density. Process 200 may proceed from 250 to 220 to move to a next search target. Additionally, process 200 may proceed from 250 to 260. At 260, feedback(s) may be provided to the mobility AI model which, at 270, may be finetuned or otherwise trained with the feedback(s).

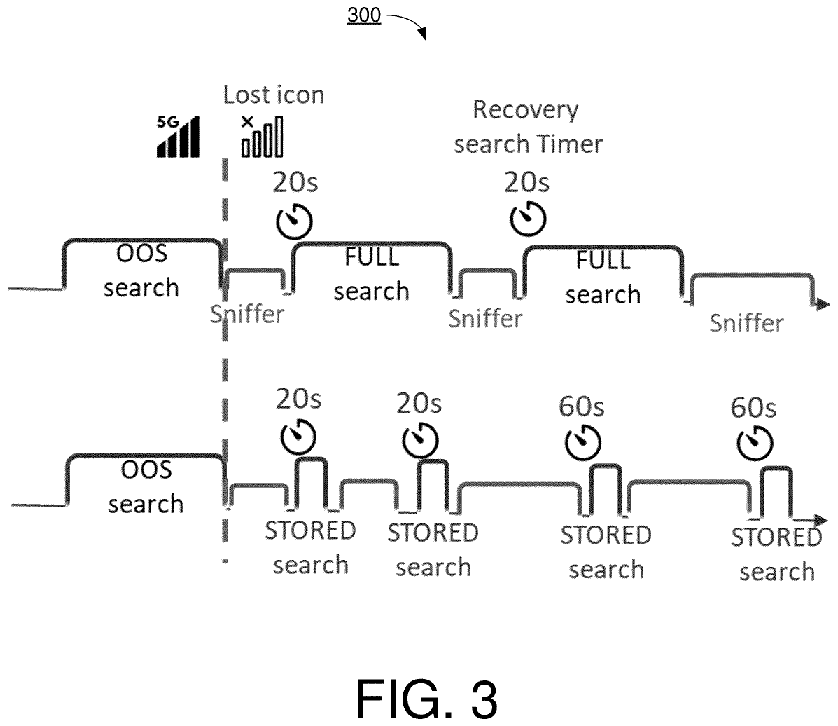

FIG. 3 illustrates an example scenario 300 under a proposed scheme in accordance with the present disclosure. Scenario 300 may pertain to various configurable system selection parameters that may be adjusted or otherwise configured. Referring to FIG. 3, some of the system selection control parameters may include, for example and not limited to, a sniffer interval, a recovery search timer, and a type of search (e.g., a full-band search or stored-only search), besides other modem internal control parameters for system selection. The sniffer interval may pertain to an interval of time that is available for UE 110 to perform sniffer function, with a frequency of the sniffer interval being based on power scan. The recovery search timer may pertain to a length of the time duration for UE 110 to perform the sniffer function (e.g., upon switch-on of UE 110 or during recovery from lack of cell coverage). The type of search may pertain to a search for a system selection target when a recovery search timer timeout, with the search being a full-band search or a search based on stored data (of past search(es)).

The various system selection control parameters at different settings or values may be combined into corresponding gears. For instance, one gear or combination (Gear 0) may include a sniffer interval of 3.2 seconds (3.2s), a recovery search timer of 20 seconds (20s) and 60 seconds (60s), and a search target of full-band search. Another gear or combination (Gear 1) may include a sniffer interval of 3.2s, a recovery search timer of 20s and 60s, and a search target of stored-only search. Another gear or combination (Gear 2) may include a sniffer interval of 4.4s, a recovery search timer of 20s and 60s, and a search target of stored-only search. Another gear or combination (Gear 3) may include a sniffer interval of 6.4s, a recovery search timer of 60s and 120s, and a search target of stored-only search. Under the proposed scheme, gear settings may be customized, configured or otherwise adjusted.

Regarding choosing which gear among the multiple gears for UE 110 to use, the determination may be based on the mobility scenario associated with UE 110 within a predefined period of time. For instance, within a sample period of 2 minutes, a sample of UE mobility may be taken every 5 seconds and, at the end of the 2 minutes, the mobility scenario of UE 110 may be determined. In case that it is determined that, for 50% of the sample period, UE 110 was in a stable scenario, a boosted or higher gear may be chosen or selected. Otherwise, a loosened or lower gear may be chosen or selected.

### Illustrative Implementations

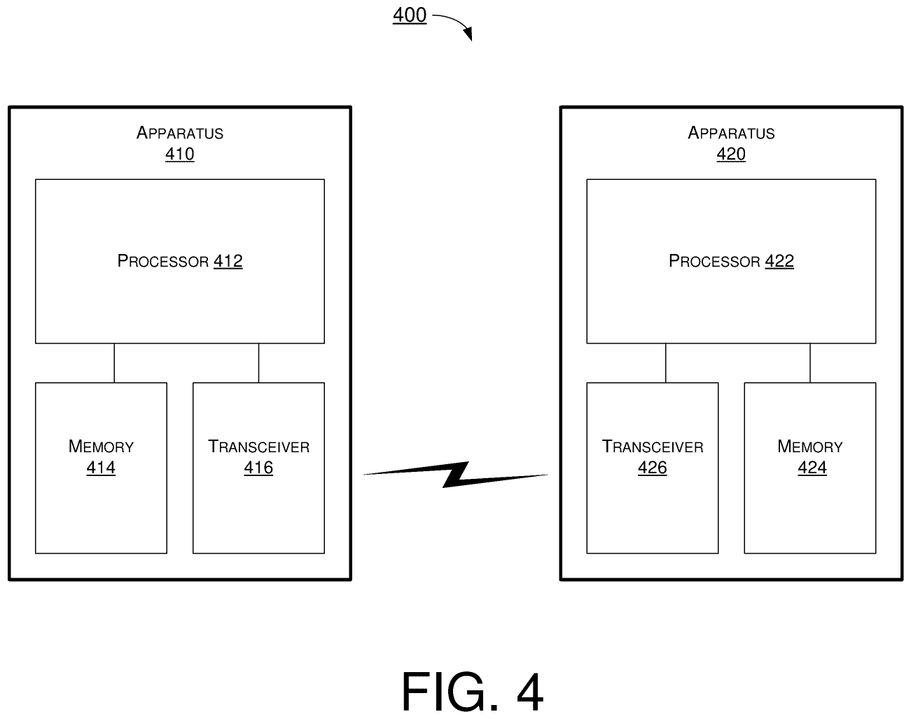

FIG. 4 illustrates an example communication system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to AI-based dynamic system selection policy adjustment in wireless communications, including the various schemes described above with respect to various proposed designs, concepts, schemes, systems and methods described above, including network environment 100, as well as processes described below.

Each of apparatus 410 and apparatus 420 may be a part of an electronic apparatus, which may be a network apparatus or a UE device (e.g., UE 110), such as a portable or mobile apparatus, a wearable apparatus, a vehicular device or a vehicle, a wireless communication apparatus or a computing apparatus. For instance, each of apparatus 410 and apparatus 420 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 410 and apparatus 420 may be implemented in a smart thermostat, a smart fridge, a smart door lock, a wireless speaker or a home control center. When implemented in or as a network apparatus, apparatus 410 and/or apparatus 420 may be implemented in an eNodeB in an LTE, LTE-Advanced or LTE-Advanced Pro network or in a gNB or TRP in a 5G network, an NR network or an IoT network.

In some implementations, each of apparatus 410 and apparatus 420 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 410 and apparatus 420 may be implemented in or as a network apparatus or a UE. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC or RISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to AI-based dynamic system selection policy adjustment in wireless communications in accordance with various implementations of the present disclosure.

In some implementations, apparatus 410 may also include a transceiver 416 coupled to processor 412. Transceiver 416 may be capable of wirelessly transmitting and receiving data. In some implementations, transceiver 416 may be capable of wirelessly communicating with different types of wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs/wireless networks of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410, as a UE device (e.g., UE 110), and apparatus 420, as a network node (e.g., network node 125) of a network (e.g., network 130 as a 5G/NR mobile network), is provided below in the context of example process 500.

### Illustrative Processes

FIG. 5 illustrates an example process 500 in accordance with an implementation of the present disclosure. Process 500 may represent an aspect of implementing various proposed designs, concepts, schemes, systems and methods described above pertaining to AI-based dynamic system selection policy adjustment in wireless communications, whether partially or entirely, including those pertaining to those described above. Process 500 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Process 500 may be implemented by or in apparatus 410 and/or apparatus 420 as well as any variations thereof. Solely for illustrative purposes and without limiting the scope, each process is described below in the context of apparatus 410 as a UE device (e.g., UE 110) and apparatus 420 as a communication entity such as a network node or base station (e.g., terrestrial network node 120) of a network (e.g., a 5G/NR mobile network). Process 500 may begin at block 510.

At 510, process 500 may involve processor 412 of apparatus 410 (e.g., UE 110) utilizing an AI model to determine a mobility scenario of an environment in which the UE is situated. Process 500 may proceed from 510 to 520.

At 520, process 500 may involve processor 412 adjusting one or more parameters used in a system selection according to a result of the determining. Process 500 may proceed from 520 to 530.

At 530, process 500 may involve processor 412 performing, via transceiver 416, the system selection with the adjusted one or more parameters. Process 500 may proceed from 530 to 540.

At 540, process 500 may involve processor 412 providing a feedback to the AI model upon performing the system selection with the adjusted one or more parameters.

In some implementations, in adjusting, process 500 may involve processor 412 loosening or decreasing a system search density in the system selection responsive to the mobility scenario being determined as a stable scenario corresponding to a low mobility of the UE. Alternatively, in adjusting, process 500 may involve processor 412 boosting or increasing a system search density in the system selection responsive to the mobility scenario being determined as an unstable scenario corresponding to a high mobility of the UE.

In some implementations, in adjusting, process 500 may involve processor 412 performing certain operations. For instance, process 500 may involve processor 412 defining a plurality of combinations of parameters, including at least a first combination of the parameters having first settings and a second combination of the parameters having second settings different from the first settings. Moreover, process 500 may involve processor 412 applying one of the combinations of the parameters corresponding to the determined mobility scenario. In some implementations, the parameters may include some or all of the following: a sniffer interval, a recovery search time, and a type of search.

In some implementations, in performing the system selection, process 500 may involve processor 412 performing certain operations. For instance, process 500 may involve processor 412 starting the system selection with a search policy associated with one or more parameters corresponding to a static scenario. Furthermore, process 500 may involve processor 412 adjusting the search policy while the UE stays in a stable scenario.

In other implementations, in performing the system selection, process 500 may involve processor 412 performing certain operations. For instance, process 500 may involve processor 412 starting the system selection with a search policy associated with one or more parameters corresponding to a non-static scenario. Moreover, process 500 may involve processor 412 adjusting the search policy while the UE stays in an unstable scenario.

In some implementations, in performing the system selection, process 500 may involve processor 412 performing a PLMN search or a cell selection.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
utilizing, by a processor of a user equipment (UE), an artificial intelligence (AI) model to determine a mobility scenario of an environment in which the UE is situated; and
adjusting, by the processor, one or more parameters used in a system selection according to a result of the determining.

2. The method of claim 1, wherein the adjusting comprises loosening or decreasing a system search density in the system selection responsive to the mobility scenario being determined as a stable scenario corresponding to a low mobility of the UE.

3. The method of claim 1, wherein the adjusting comprises boosting or increasing a system search density in the system selection responsive to the mobility scenario being determined as an unstable scenario corresponding to a high mobility of the UE.

4. The method of claim 1, wherein the adjusting comprises:
defining a plurality of combinations of parameters, including at least a first combination of the parameters having first settings and a second combination of the parameters having second settings different from the first settings; and
applying one of the combinations of the parameters corresponding to the determined mobility scenario.

5. The method of claim 4, wherein the parameters comprise some or all of a sniffer interval, a recovery search time, and a type of search.

6. The method of claim 1, further comprising:
performing, by the processor, the system selection with the adjusted one or more parameters.

7. The method of claim 6, wherein the performing of the system selection comprises:
starting the system selection with a search policy associated with one or more parameters corresponding to a static scenario; and
adjusting the search policy while the UE stays in a stable scenario.

8. The method of claim 6, wherein the performing of the system selection comprises:
starting the system selection with a search policy associated with one or more parameters corresponding to a non-static scenario; and
adjusting the search policy while the UE stays in an unstable scenario.

9. The method of claim 6, wherein the performing of the system selection comprises performing a public land mobile network (PLMN) search or a cell selection.

10. The method of claim 6, further comprising:
providing, by the processor, a feedback to the AI model upon performing the system selection with the adjusted one or more parameters.

11. An apparatus implementable in a user equipment (UE), comprising:
a transceiver configured to communicate wirelessly; and
a processor coupled to the transceiver and configured to perform operations comprising:
utilizing an artificial intelligence (AI) model to determine a mobility scenario of an environment in which the UE is situated; and
adjusting one or more parameters used in a system selection according to a result of the determining.

12. The apparatus of claim 11, wherein the adjusting comprises loosening or decreasing a system search density in the system selection responsive to the mobility scenario being determined as a stable scenario corresponding to a low mobility of the UE.

13. The apparatus of claim 11, wherein the adjusting comprises boosting or increasing a system search density in the system selection responsive to the mobility scenario being determined as an unstable scenario corresponding to a high mobility of the UE.

14. The apparatus of claim 11, wherein the adjusting comprises:
defining a plurality of combinations of parameters, including at least a first combination of the parameters having first settings and a second combination of the parameters having second settings different from the first settings; and
applying one of the combinations of the parameters corresponding to the determined mobility scenario.

15. The apparatus of claim 14, wherein the parameters comprise some or all of a sniffer interval, a recovery search time, and a type of search.

16. The apparatus of claim 11, wherein the processor is further configured to perform operations comprising:
performing, by the processor, the system selection with the adjusted one or more parameters.

17. The apparatus of claim 16, wherein the performing of the system selection comprises:
starting the system selection with a search policy associated with one or more parameters corresponding to a static scenario; and
adjusting the search policy while the UE stays in a stable scenario.

18. The apparatus of claim 16, wherein the performing of the system selection comprises:
starting the system selection with a search policy associated with one or more parameters corresponding to a non-static scenario; and
adjusting the search policy while the UE stays in an unstable scenario.

19. The apparatus of claim 16, wherein the performing of the system selection comprises performing a public land mobile network (PLMN) search or a cell selection.

20. The apparatus of claim 16, wherein the processor is further configured to perform operations comprising:
providing, by the processor, a feedback to the AI model upon performing the system selection with the adjusted one or more parameters.
